(19) United States
(12) Patent Application Publication
(10) Pub. No.: US 2014/0149301 A1
(43) Pub. Date: May 29, 2014

(54) SOCIAL NETWORK DRIVEN SYSTEM AND METHODS FOR ENVIRONMENTAL PLANNING AND DESIGN

(71) Applicants: Janis L. Dickinson, Ithaca, NY (US); Chris Marx, Ithaca, NY (US); Caren B. Cooper, Ithaca, NY (US); Rhiannon L. Crain, Ithaca, NY (US)

(72) Inventors: Janis L. Dickinson, Ithaca, NY (US); Chris Marx, Ithaca, NY (US); Caren B. Cooper, Ithaca, NY (US); Rhiannon L. Crain, Ithaca, NY (US)

(73) Assignee: CORNELL UNIVERSITY, Ithaca, NY (US)

(21) Appl. No.: 13/812,308

(22) PCT Filed: Jul. 25, 2011
(86) PCT No.: PCT/US11/45172

§ 371 Date: Feb. 26, 2013

Related U.S. Application Data
(60) Provisional application No. 61/367,680, filed on Jul. 26, 2010.

(51) Int. Cl. G06Q 50/00; G06Q 10/00

(52) U.S. Cl. CPC G06Q 50/01; G06Q 10/00
USPC 705/319

(57) ABSTRACT

A social network driven system and methods directed to the planning and design of an environment that enables users to share and exchange information related to components and elements related to the parcel as well as the consequences or impact of a particular architectural landscape.

The present application claims priority to U.S. Provisional Patent Application No. 61/367,680 filed Jul. 26, 2010, the disclosure of which is hereby incorporated by reference in its entirety.

### STATEMENT CONCERNING FEDERALLY SPONSORED RESEARCH

This invention was made with U.S. government support, National Science Foundation No. 0917487. The U.S. government may have certain rights in the invention.

### FIELD OF THE INVENTION

The invention relates generally to a social network. More specifically, the invention relates to a social network driven system and methods that enables users to share and exchange information regarding environmental planning and design such as architectural landscaping of a parcel. Users may share and exchange information related to components and elements positioned on the parcel and the related consequences or impact of a particular architectural landscape.

### BACKGROUND OF THE INVENTION

Over the past few decades, urban and suburban developments have grown at unprecedented rates. These developments have grown with unknown consequences on ecosystem functionality. When an environment is designed including the placement of certain items such as trees, shrubs, and flowers, the consequences (positive or negative) of the design are rarely considered. For example, a particular landscape design may affect habitat-animal relationships such as attracting a certain species of birds.

There are numerous reasons why a person would want to know the consequences of a particular environmental design as well as collaborate with others that may have knowledge regarding a particular environmental design. For example, with the growing concern over global warming, a person may be interested to know that certain materials such as concrete, mulch, topsoil, and the placement of those materials may result in contributions to greenhouse gas emissions. In designing an environment, a person may wish to choose certain objects or materials or behaviors with small carbon footprints to reduce the environmental effect on greenhouse gas emissions.

After an environment has been designed, a person may wish to share the design, knowledge, or consequences of the design with others such as through a social network. Social network websites and applications are continuously increasing in popularity. A social network is a social structure made up of users such as individuals or organizations that are interconnected by a common interest. More specifically, social networks are typically online communities of users who share interests and activities, or who are interested in exploring the interests and activities of others. Social networks provide a variety of ways for users to interact, such as through instant messaging, e-mail messaging or posting and sharing content for certain users or all users to view.

Social networks provide several advantages. Social networks facilitate connections with users sharing the same or similar interest. Social networks also provide a means of communication and dissemination of up-to-date information. For example, a user may keep informed on recent happenings with other users within the social network. Social networks may provide understanding and education on a particular interest or activity and allow users to band together to create strong alliances for a certain cause.

Although there are a variety of mapping applications that allow a user to design and plan space such as home interior, home exterior, and office space, these mapping applications do not incorporate a social network component that facilitates discussion between users regarding the space and items located within the space. In particular, there is not a social network driven system and methods for habitat mapping including architectural landscaping that allows users to position items within a parcel of land to see how the item looks in relation to other items, review the consequences of certain items on the overall design, and share information related to the items or design with others both through visualizations and online discussions about the visualized sites, areas, elements, or objects. The invention satisfies this demand.

### SUMMARY OF THE INVENTION

Disclosed is a social network directed to the planning and design of an environment, specifically a piece of land or site otherwise referred to herein as “property” or “parcel”. The planning and design of an environment is referred to herein as “habitat mapping”. Habitat mapping emphasizes the role of sustainable landscaping practices in creating healthy habitats and allows presentation of all types of activities, sustainable or not. Habitat mapping permits an understanding of consequences of landscaping practices and products and particularly how land can be designed and managed to obtain a certain result such as to minimize negative effects and maximize positive effects on a parcel.

“Landscaping practices” is any product or activity that modifies the aesthetic, ecological, biological, and/or environmental aspects of a property. Products associated with landscaping may include for example, vegetation, animals, items created and/or installed by humans such as buildings and structures including fences and bird feeders. Activities associated with landscaping may include for example, gardening, composting, collecting rainwater, and reducing the use of fossil fuels.

The invention allows users—otherwise referred to as “mappers”—to collaborate, coordinate and communicate with respect to a parcel and all components and elements of the parcel through a social network that is integrated within the habitat mapping application. It is contemplated that a user or mapper may be a person, group of people, entity, institution, company, etc. According to the invention, the social network is a community of users that share a common interest related to habitat mapping. The social network creates a framework for discussing how certain practices and products affect the characteristics and outputs of the environment. The sharing of information via a social network educates users and catalyzes the adoption of sustainable landscaping practices.

Habitat mapping may be useful in a variety of applications, for example, crowdsourcing for environmental assessment and planning, development planning, natural resource inventories such as those required for easement evaluation, communication of eco-resources and other activities by hotels and resorts, incorporation into online real-estate sales, facilitation of “greening” an environment such as corporate campuses, research on habitat change over time, or association of a habitat with economical, educational, financial, or other information of interest.

Habitat mapping may also be useful in scientific applications. Data can be collected from various parcels to reach scientific conclusions such as determining what practices improve the wildlife value of residential landscapes and which of these practices have the greatest impact, how large an area the practices have to be implemented over to really make a difference, the impact of urban and suburban wildlife corridors and stopover habitats on birds, and measures that show the greatest impact on bird counts or nesting success.

It is also contemplated that habitat mapping according to the invention may be used in natural disaster tracking, for example moving the boundaries of a hurricane or wildfire while allowing people to make comments, ask for help, add their own observations, obtain information, and share information with others. The invention may also be used to map locations of radiation hotspots so that anyone moving into an area can view the radiation landscape prior to entering a specific location. The invention may also be used in mapping disease risk zones or to locate regions where rabid or dangerous animals were spotted. In conditions of quarantine, the invention may be used to convey information to a centralized database and to schedule assistance such as food drop offs. It is even contemplated that the invention may be used to map areas and objects related to missing persons or fugitives.

The invention facilitates conversation between people regarding the identified pieces of land and its related components, including comments and questions such as: “Those trees look great! Why did you select those flowers? Did your irrigation practice affect plant growth?” Furthermore, the invention facilitates conversation between people regarding a collection of identified pieces of land and its related components, for example: “Why doesn't our neighborhood have more trees? Let's plant some! Why are we loosing trees? Do we have a problem with the eastern tent caterpillar, chestnut blight or the ash borer? Let's call an arborist!” The social network provides a way for people to reach out to other people such as to boast innovative solutions, constructively criticize, and offer insight that others may not know. It is contemplated that conversation including comments and questions between users may appear on news feeds such as those of other users in the social network.

The invention may also facilitate the commercialization and monetization of parcels. If a person who has recorded everything done to his or her property through the system and methods of the invention wishes to sell the property, then a potential buyer knows what added value they are getting with the purchase of the property. All such properties with a good environmental record (e.g., no pesticide use for five years) that are up for sale can be categorized and each sold arguably for a premium. A whole neighborhood that uses the system according to the invention can demonstrate why someone should buy a property in their neighborhood and not elsewhere, thereby driving up the demand, and price of the neighborhood properties. For example, a town can identify itself as “green” meaning that no pesticides are applied on the lawns throughout the town.

The invention also aggregates data such as that related to a particular interest or activity such as data on birds, vegetation, or irrigation. As mentioned above, data can be collected to reach scientific conclusions. Data may be gathered to determine the overall health of the property, the amount of water required to sustain the environment or the type of water cachement system that works best during winter months, for example.

According to the invention, a piece of land or site is selected for planning and design. A piece of land represented by an electronic file—referred to as a “parcel” or “parcel map”—is selected by either accessing a web service application or a database. In the embodiment where the parcel is selected from a database, the user or mapper retrieves a parcel by navigating through a plurality of parcels within the database. In the embodiment where the parcel is selected from a web mapping service application, the mapper navigates through map images. Map images may be aerial images such as geo-referenced map images generated by a geographic information system (“GIS”) or satellite images generated by a global positioning system (“GPS”). Examples of web mapping service applications include Open Layers Framework, Yahoo!® Maps, Google® Maps, Google® Earth, OpenStreetMap, and WikiMapia, although a user created web mapping service application is also contemplated.

While navigating through a database or a web service application, the mapper may search for the parcel in a variety of ways. The mapper may search by name, address, ecoregion, site marker, date and/or time associated with the parcel, or particular characteristic such as type of parcel, one that includes a particular tree species, or one that does not use pesticides, for example.

In certain embodiments, the boundaries of the parcel map may be defined. A virtual graphics tool may be used to compose a closed sequence of lines forming a polygon that defines the parcel map. The term “parcel map polygon” refers to the piece of land or site selected and/or defined by outlining the boundaries to form a polygon.

The mapper designs the selected parcel map by adding features such as parcel type, habitat components, and object elements. The features may be selected from a feature library such as through a drop-down menu or list menu. The features may also be selected by searching for the feature, such as by name or characteristics. For example, the mapper may identify that he or she desires an object element for the parcel map that is a perennial, deciduous, or that has drought tolerance such as Canadian Bluegrass. The mapper may also select a feature of his or her own such as by user-reporting the feature. User-reporting allows a user to define characteristics of the feature or provide data that is used to calculate the characteristics of a feature. The mapper may also provide an image or photograph of the user-reported feature. It is contemplated that any user-reported feature may be added to a feature library for later use by the mapper or for use by other users of the habitat mapping application.

The parcel map may be categorized within the system according to the type of parcel. For example, the parcel may be categorized as one or more of the following: home, school, community garden, farm, park, nature preserve, office, or any other type as specified by the mapper. A home parcel may be private property residential locations that are either owned or rented. A home parcel type includes a variety of different sized green-space ranging from a small yard to several acres. A school parcel type may be a private or public location and may include an athletic field, playground, gym, or track where students participating in sports or physical education practice. A community garden parcel type is a parcel gardened collectively by a group of people. A farm is a parcel devoted primarily to the practice of producing and managing food and can be of any size from a fraction of an acre to several thousand acres. Farms include orchards, vineyards, stables, dairy farms, fish farms, tree farms, flower farms, and plantations. A park is a parcel set aside for recreation and enjoyment and a nature preserve is a protected parcel set aside for the protection of wildlife or natural habitats. An office is a parcel in which people work.

After the parcel map is categorized according to parcel type, habitat components are selected, such as from a habitat component library, for placement on the parcel map. For purposes of this application, the term “habitat component” is an icon to identify anything that exists on the parcel map. Habitat components include building, lawn, forest, grass, desert, edibles, flowers, herbs, ground, pavement, shrubs, water, wetland, to name a few. The mapper chooses the habitat component and places the habitat component on the parcel map. In certain embodiments, the user uses the virtual graphics tool to create a polygon thereby outlining the habitat component for placement on the parcel map.

After the habitat components are placed and identified on the parcel map, object elements are selected, such as from an object library, and positioned on the parcel map. For purposes of this application, the term “object element” is a symbol to identify any thing that may be positioned on the parcel map such as vegetation including bushes, trees, flowers, and grass to name a few or composition such as sheds, bird feeders, bird house, rock, dead wood and mulch. The term “object element” may also be used herein to refer to a symbol that identifies an action performed on the parcel map such as a compost bin to identify composting matter, a rain barrel to identify collecting rainwater, or a solar panel to identify reducing the use of fossil fuels. The mapper chooses the object element and places the object element on the parcel map. In certain embodiments, the user uses the virtual graphics tool to create a polygon thereby outlining the object element for placement on the parcel map.

Habitat components and object elements are two-dimensional (“2D”) digitized features. Although the digitized features are discussed and illustrated herein as 2D, it is contemplated that the digitized features may be three-dimensional (“3D”).

After the mapper selects the feature and determines its position or placement on the parcel map, the mapper can manipulate the digitized feature according to size, shape, and characteristics. The size and shape can be defined by using a virtual graphics tool similar to the one used for defining the boundaries of the parcel. A polygon may be formed that defines the size and/or shape of the feature. In addition to a virtual graphics tool, it is also contemplated that a drag tool may be used to drag the feature to a desired size and/or shape.

Digitized features also allow a mapper to interact with the social network through the feature itself by performing an action. More specifically, each feature includes its own feature window such that once the feature is arranged on the parcel map, the mapper can assign a title, post a comment to the social network, display photos or videos, deliver sounds, distinguish attributes related to the feature, and provide a status tag such as “point to”, “like”, “flag” and “share” by populating the feature window.

Titles assigned to the feature can be used to add the feature to an existing library so that other mappers may select it when planning and designing their parcel map. Titles also assist in identifying a specific feature. Any comments posted with the feature remain associated with the feature. In addition to any comments posted by the mapper that is designing and planning the parcel map, users that view the parcel map may also post comments such as those in response to previously posted comments. Therefore, the invention does not send users to a separate social network application, but acts as the social network in and of itself. The feature window also allows the user to distinguish attributes of the component or element by categorizing actions, practices, behaviors, or characteristics. In one embodiment, the user may distinguish attributes by selecting checkboxes or bullet points representing attributes such as: deciduous tree, thorny, nuts, not native, seed, seed cones or berries. It is also contemplated that users can distinguish attributes of the feature by linking to other information, for example, the United States Department of Agriculture (“USDA”) plant list. The user may also distinguish attributes by entering free-form text. The feature window also permits users to add comments or notes related to the feature that may be instantaneously published on the social network.

Each feature may also have a “quick view” such that when a user hovers over the feature, a window of information pops up such as an overview of the feature.

Communication and collaboration occurs within the habitat mapping application for direct sharing of information. By having a social network integrated within the habitat mapping application, direct collaboration, coordination and communication occurs within the parcel itself. Through a social network and online resources, the system allows for outcomes to be tracked using standard evaluation techniques.

The invention provides a learning tool such that users can learn about the consequences or impact a particular design has on a parcel. Consequences are calculated from analyzing the parcel map and can be anything related to a particular architectural landscape.

Consequences of landscaping practices and products include both positive and negative results. Consequences may relate to any effect on the parcel and/or components of the parcel. Consequences can range from a user merely deciding that they like a particular design to an increase in hummingbirds, for example. Specifically, results may pertain to natural elements such as erosion including changes to terrain shape and elevation, evaporation of water bodies such as rivers and lakes. Results may also include changes to living elements such as an increase in wildlife, a decrease in land cover, and failure for trees to survive. It is also contemplated that results may pertain to abstract elements such as lighting or shade. Results may also related to the parcel as a whole, for example, land surface temperature, percent lawn, pesticide use, water consumption, type of conservation strategy, energy consumption, carbon footprint, carbon footprint reduction strategy, carbon emissions, and reported pollution reduction, to name a few.

Specifically, consequences may be an increase in land surface temperature, a fluctuation in water consumption or energy consumption, a decrease in carbon footprint or carbon emission value, a measurement of greenhouse gases produced, or a particular species of bird that is attracted to the parcel. Consequences may also include data related to a particular architectural landscape. For example, data may include characteristics collected about vegetation composition such as the percent native. As another example, data may be collected on successful ecological restoration including the amount that non-native species and woody vegetation was reduced or the identification of species that was successfully planted in an environment or details on successful post-seeding management. It is also contemplated that consequences may be a summary of statistics such as the percentage of land cover within each polygon or overall area. Any consequence of one parcel map may also be compared to other consequences of other parcel maps. A comparison tool may be based on a focus theory of normative conduct.

It is contemplated that the system and methods according to the invention is accessed through a computing device. To facilitate greater mobility, the computing device may be handheld and include any small-sized computing device including a display interface. Examples of such devices include a personal digital assistant (“PDA”), smart hand-held computing device, cellular telephone, or a laptop or netbook computer, hand held console or MP3 player, tablet, or similar hand held computer device, such as an iPad®, iPad Touch® or Phone®.

It is contemplated that the computing device may use the Internet or any other system of interconnected computer networks including cloud computing networks. Additionally, the system and methods may be accessed through a network that is wired or wireless.

The described embodiments are to be considered in all respects only as illustrative and not restrictive, and the scope of the invention is not limited to the foregoing description. Those of skill in the art will recognize changes, substitutions and other modifications that will nonetheless come within the scope of the invention and range of the claims.

### DESCRIPTION OF THE DRAWINGS

The preferred embodiments of the invention will be described in conjunction with the appended drawing provided to illustrate and not to the limit the invention, where like designations denote like elements, and in which:

FIG. 1 is a flow chart for planning an environment according to one embodiment of the invention;

FIG. 2 is a schematic view of one embodiment of a computing device according to the invention;

FIG. 3 illustrates an exemplary cloud computing system that may be used to implement the invention;

FIG. 4 is a screen view of the user interface of a computing device according to one embodiment of the invention;

FIG. 5 is a screen view of the user interface of a computing device according to another embodiment of the invention;

FIG. 6 is a screen view of the user interface of a computing device according to another embodiment of the invention;

FIG. 7 is a screen view of the user interface of a computing device according to another embodiment of the invention;

FIG. 8 is a screen view of the user interface of a computing device according to another embodiment of the invention;

FIG. 9 is a screen view of the user interface of a computing device according to another embodiment of the invention;

FIG. 10 is a screen view of the user interface of a computing device according to another embodiment of the invention;

FIG. 11 is a screen view of the user interface of a computing device according to another embodiment of the invention;

FIG. 12 is a screen view of the user interface of a computing device according to another embodiment of the invention;

FIG. 13 is a screen view of the user interface of a computing device according to another embodiment of the invention;

FIG. 14 is a screen view of the user interface of a computing device according to another embodiment of the invention;

FIG. 15 is a screen view of the user interface of a computing device according to another embodiment of the invention; and

FIG. 16 is a screen view of the user interface of a computing device according to another embodiment of the invention.

### DETAILED DESCRIPTION OF THE PREFERRED EMBODIMENT

Although a number of embodiments of the invention will be described in the following, it is understood that these embodiments are presented by way of example only, not limitation. The detailed description of the exemplary embodiments of the invention should not be construed to limit the scope or breadth of the invention.

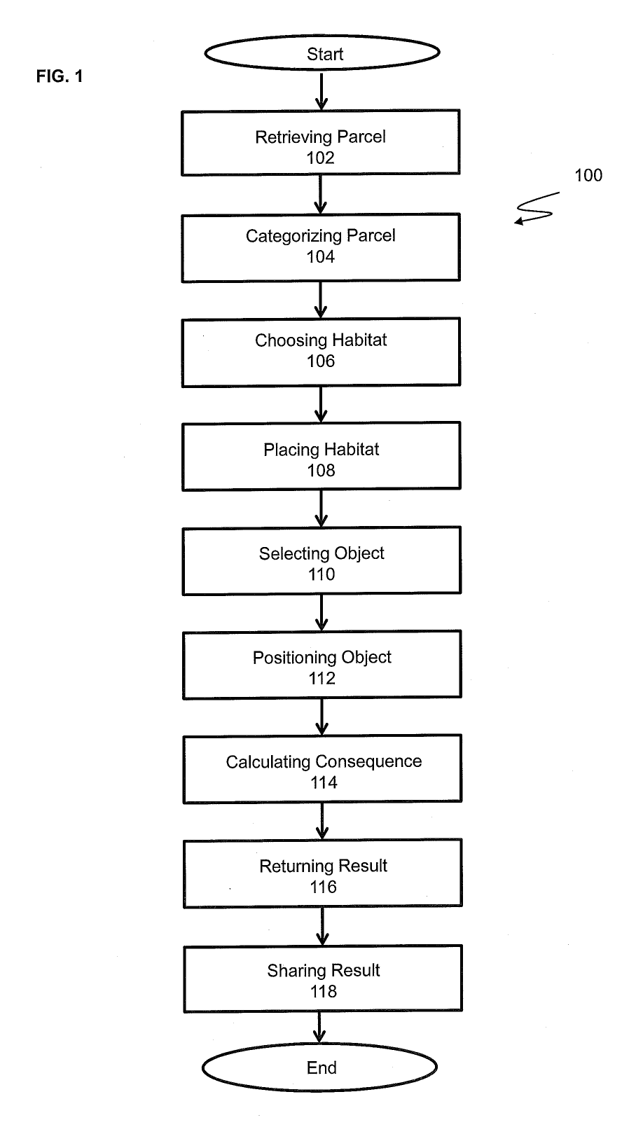

FIG. 1 is a flow chart for planning an environment according to one embodiment of the invention. According to one embodiment of the invention, a parcel is selected by either accessing a web service application or a database. Specifically, the parcel is retrieved at step 102 from a database or from a web mapping service application. A user may retrieve the parcel by searching for the parcel by name, address, ecoregion, site marker, date and/or time associated with the parcel, or a particular characteristic such as a parcel that includes a particular tree species, such as Arborvitae. The parcel is defined by outlining the boundaries forming a polygon. At step 104, the user categorizes the parcel according to the type of parcel.

The user selects one or more of the following types of parcels: home, school, community garden, farm, park, nature preserve, office, and/or other. If “other” parcel type is selected, the user may enter his or her own type of parcel along with any defining attributes.

The user then chooses a habitat component from a habitat component library at step 106 and places the habitat component on the parcel map at step 108. The user may place the habitat component on the parcel map by using a virtual graphics tool to create a polygon outlining the habitat component or may place and manipulate the component such as by dragging the component to a desired size and/or shape.

At step 110, the user selects an object element from an object element library and positions the object element on the parcel map at step 112. Similar to the habitat component, the user may place the object element on the parcel map by creating a polygon outlining the element or by placing and manipulating the element by dragging it to a desired size and/or shape.

Consequences are calculated at step 114 from analyzing the parcel map and the result is returned to the user at step 116. The user may share the result as well as the entire parcel map as planned and designed at step 118 through the use of a social network.

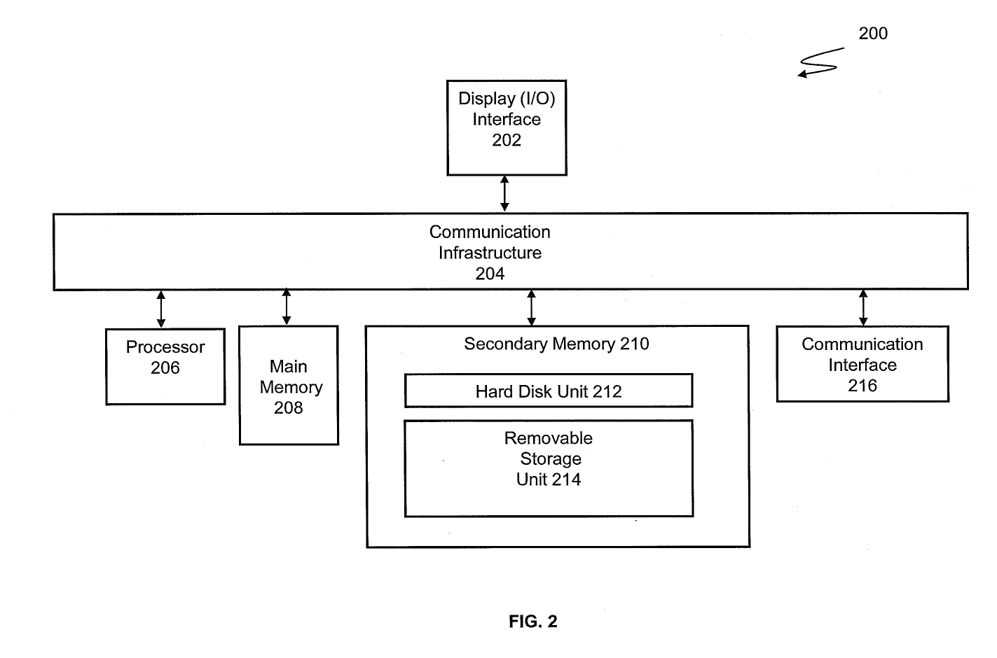

FIG. 2 illustrates an exemplary computer device 200 that may be used to implement the methods according to the invention. One or more computing devices 200 may carry out the methods presented herein as computer code.

Computing device 200 includes an input/output display interface 202 connected to communication infrastructure 204—such as a bus—, which forwards data such as graphics, text, and information from the communication infrastructure 204 or from a frame buffer (not shown) to other components of the computing device 200. The input/output display interface 202 may be, for example, a keyboard, touch screen, joystick, trackball, mouse, monitor, speaker, printer, any other computer peripheral device, or any combination thereof, capable of entering and/or viewing data.

Computing device 200 includes one or more processors 206, which may be a special purpose or a general-purpose digital signal processor that processes certain information. Computing device 200 also includes a main memory 208, for example random access memory (“RAM”), read-only memory (“ROM”), mass storage device, or any combination thereof. Computing device 200 may also include a secondary memory 210 such as a hard disk unit 212, a removable storage unit 214, or any combination thereof. Computing device 200 may also include a communication interface 216, for example, a modem, a network interface (such as an Ethernet card or Ethernet cable), a communication port, a PCMCIA slot and card, wired or wireless systems (such as Wi-Fi, Bluetooth, Infrared), local area networks, wide area networks, intranets, etc.

It is contemplated that the main memory 208, secondary memory 210, communication interface 216, or a combination thereof, function as a computer usable storage medium, otherwise referred to as a computer readable storage medium, to store and/or access computer software including computer instructions. For example, computer programs or other instructions may be loaded into the computing device 200 such as through a removable storage device, for example, a floppy disk, ZIP disk, magnetic tape, portable flash drive, optical disk such as a CD or DVD or Blu-ray, Micro-Electro-Mechanical System (“MEMS”), or nanotechnological apparatus. Specifically, computer software including computer instructions may be transferred from the removable storage unit 214 or hard disc unit 212 to the secondary memory 210 or through the communication infrastructure 204 to the main memory 208 of the computing device 200.

Communication interface 216 allows software, instructions and data to be transferred between the computing device 200 and external devices or external networks. Software, instructions, and/or data transferred by the communication interface 216 are typically in the form of signals that may be electronic, electromagnetic, optical, or other signals capable of being sent and received by the communication interface 216. Signals may be sent and received using wire or cable, fiber optics, a phone line, a cellular phone link, a Radio Frequency (“RF”) link, wireless link, or other communication channels.

Computer programs, when executed, enable the computing device 200, particularly the processor 206, to implement the methods of the invention according to computer software including instructions.

The computing device 200 described herein may perform any one of, or any combination of, the steps of any of the methods presented herein. It is also contemplated that the methods according to the invention may be performed automatically, or may be invoked by some form of manual intervention.

The computing device 200 of FIG. 2 is provided only for purposes of illustration, such that the invention is not limited to this specific embodiment. It is appreciated that a person skilled in the relevant art knows how to program and implement the invention using any structure for a computing device.

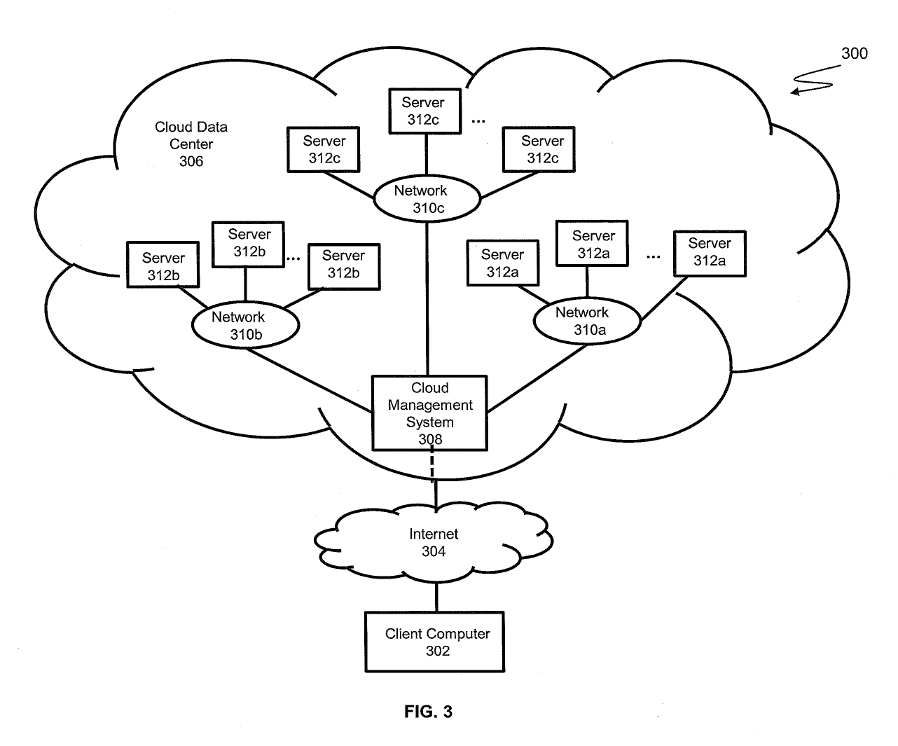

FIG. 3 illustrates an exemplary cloud computing system 300 network architecture that may be used to implement the invention. The cloud computing system 300 includes a plurality of interconnected computing environments. The cloud computing system 300 utilizes the resources from various networks as a collective virtual computer, where the services and applications can run independently from a particular computer or server configuration making hardware less important.

Specifically, the cloud computing system 300 includes at least computing device 200, such as that as described in reference to FIG. 2, through the use of which a distributed computing environment may be accessed to perform the methods disclosed herein.

The communication interface 216 allows communication through transferred signals between the computing device 200 and external devices including networks such as the Internet 304 and cloud data center 306. The computing device 200 establishes communication with the Internet 304—specifically to one or more servers—to, in turn, establish communication with one or more cloud data centers 306. A cloud data center 306 includes one or more networks 310a, 310b, 310c managed through a cloud management system 308. Each network 310a, 310b, 310c includes resource servers 312a, 312b, 312c, respectively. Servers 312a, 312b, 312c permit access to a collection of computing resources and components that can be invoked to instantiate a virtual machine, process, or other resource for a limited or defined duration. For example, one group of resource servers can host and serve an operating system or components thereof to deliver and instantiate a virtual machine. Another group of resource servers can accept requests to host computing cycles or processor time, to supply a defined level of processing power for a virtual machine. A further group of resource servers can host and serve applications to load on an instantiation of a virtual machine, such as the social network application, or other applications or software.

The cloud management system 308 can comprise a dedicated or centralized server and/or other software, hardware, and network tools to communicate with one or more networks 310a, 310b, 310c, such as the Internet or other public or private network, with all sets of resource servers 312a, 312b, 312c. The cloud management system 308 may be configured to query and identify the computing resources and components managed by the set of resource servers 312a, 312b, 312c needed and available for use in the cloud data center 306. Specifically, the cloud management system 308 may be configured to identify the hardware resources and components such as type and amount of processing power, type and amount of memory, type and amount of storage, type and amount of network bandwidth and the like, of the set of resource servers 312a, 312b, 312c needed and available for use in the cloud data center 306. Likewise, the cloud management system 308 can be configured to identify the software resources and components, such as type of Operating System (“OS”), application programs, and the like, of the set of resource servers 312a, 312b, 312c needed and available for use in the cloud data center 306.

The cloud computing system 300 of FIG. 3 is provided only for purposes of illustration and does not limit the invention to this specific embodiment. It is appreciated that a person skilled in the relevant art knows how to implement the invention using any network architecture.

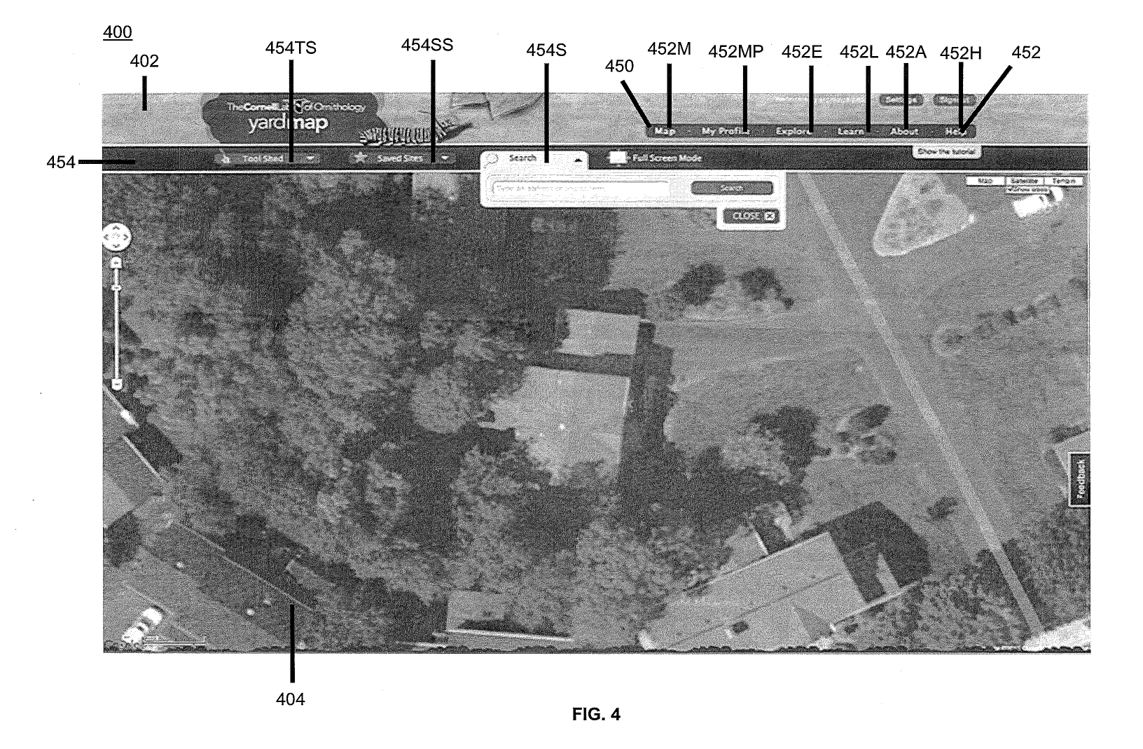

The display interface 202 (FIG. 2) allows a user to control and interact with one or more of the screen views 221 of the system and methods as shown in FIG. 4 through FIG. 15,

Certain preferred embodiments of a habitat mapping application are identified in the Drawings by the number 400. One preferred embodiment of the computing device 200 (FIG. 2) includes display interface 202 that allows users, for example, to control and interact with the habitat mapping application 400 presented as screen views 402 as shown in FIG. 4 through FIG. 15. To assist the mapper in making decisions, inputting information, navigating and using the screen views 402, embodiments of the habitat mapping application 400 may include graphical controls 450.

The graphical controls 450 may be in the form of images, icons, text prompts, text commands, text messages, field boxes, symbols, hyperlinks, or other graphical elements that appear on one or more of the screen views 402. The graphical controls 450 allow a user to control and interact with the application 400. In certain embodiments, the direct manipulation of the graphical controls 450 allows actions to be performed and input given.

Such graphical controls 450 may be used also to confirm how the user has manipulated the habitat mapping application 400. In one embodiment, such graphical controls 450 require touch screen technology that is included with many computing devices 200. The graphical controls 450 are on the display interface 202 (FIG. 2), specifically, on the surface of the screen view 402.

The screen views 402 of the habitat mapping application 400 are accessed by a security feature that includes a login component and a password component, and the application 400 is exited through a sign-out component. The user or mapper successfully accesses the application 400 by providing the correct login and password and exits the application 400 by selecting the sign-out component. Once the mapper accesses the application 400, the screen views 402 as shown in FIG. 4 through FIG. 15 may be provided.

As shown in FIG. 4, the habitat mapping application 400 includes a graphical control 450 in the form of a main menu bar 452. The main menu bar 452 further includes graphical controls 450 in the form of buttons that include Map 452M, My Profile 452MP, Explore 452E, Learn 452L, About 452A, and Help 452H. The application 400 also includes a graphical control 450 in the form of a selection bar 454. The selection bar 454 includes graphical controls 450 in the form of buttons that include Tool Shed 454TS, Saved Sites 454SS, and Search 454S. Unless specifically stated otherwise, for purposes of this application, the term “button” will mean an area on the screen view 402 that includes touchscreen technology that reacts to the touch of the user.

The Map button 452M provides the mapper with graphical controls 450 to select and retrieve a piece of land or site for planning and design. The user may select the parcel from a database or from a web service application. In the embodiment where the parcel is selected from a database, the mapper retrieves a parcel by navigating through a plurality of parcels within the database under the Saved Sites button 454SS. As shown in FIG. 4, a mapper uses a web mapping service application, specifically Google® Maps. The mapper navigates through map images such as by using the Search button 454S to search for the parcel by address. After the parcel is located and selected, the screen view 402 illustrates the image 404 on the surface of the display interface 202 (FIG. 2).

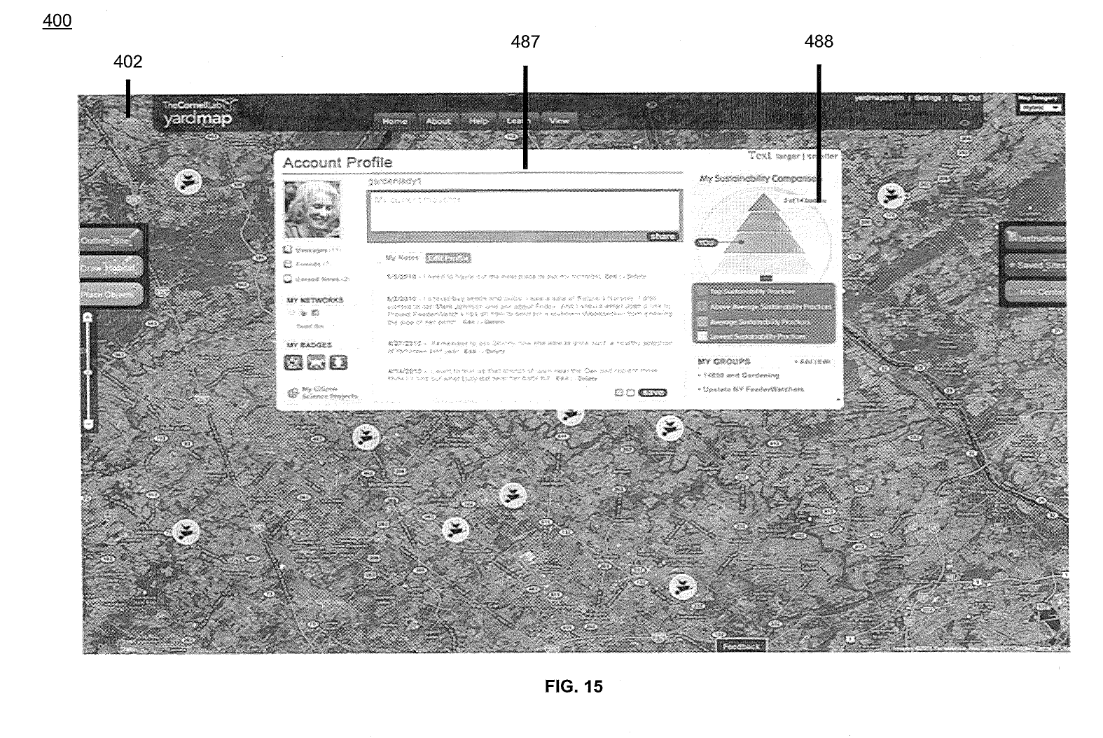

The button My Profile 452MP allows mappers to designate specifics regarding his or her profile, for example, name, login, password, address, contact information, badges, etc. The My Profile button 452MP also allows users to post and review comments and notes as well as connect with other users as described more fully in reference to FIG. 15. The Explore button 452E allows users to investigate details of the piece of land or site selected, for example, the ecoregion in which the parcel resides, the plant hardiness zone, state recommended natives, and information that is local to the parcel such as landscaping experts, birds, plant nurseries, community gardens, and links of interest, to name a few. The Learn button 452L educates users on various tools within the habitat mapping application 400. For example, the mapper can learn the definition of a habitat as well as learn about specific elements or components of a habitat such as food, water, structure, wildlife, pesticides, and fertilizers. The user may also learn about cultivating habitat, habitat types and ecological traps by selecting the Learn button 452L. The Learn button 452L may also be selected so that users can learn about the consequences or impact a particular design has on a parcel.

The About button 452A merely provides information on the habitat mapping application 400 itself and the Help button 452H may be selected by a user that needs assistance with the application 400.

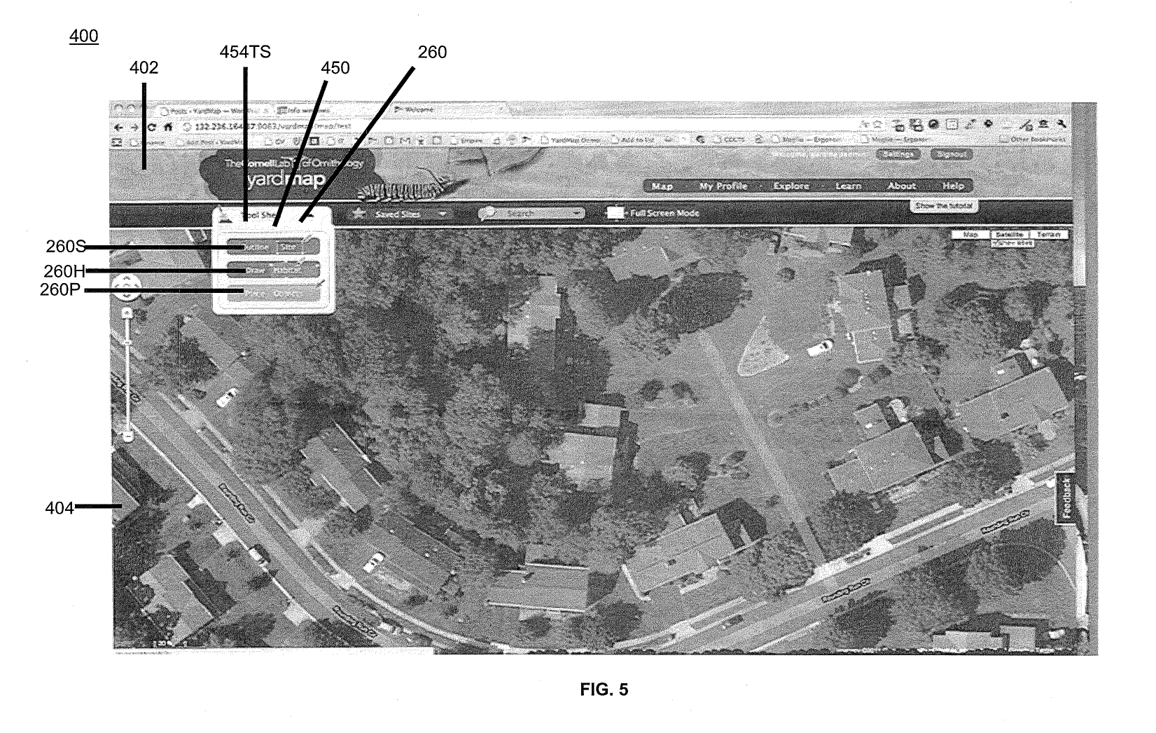

As shown in FIG. 5, the user may select on the screen view 402 the Tool Shed button 454TS, which a drop down element 260. The drop-down element 260 may be engaged to provide “scrolling” action downward or upward to facilitate the selection of additional buttons that are not initially shown on the drop-down element 260. As shown, the drop-down element 260 includes buttons Outline Site 260S, Draw Habitat 260H, and Place Objects 260P.

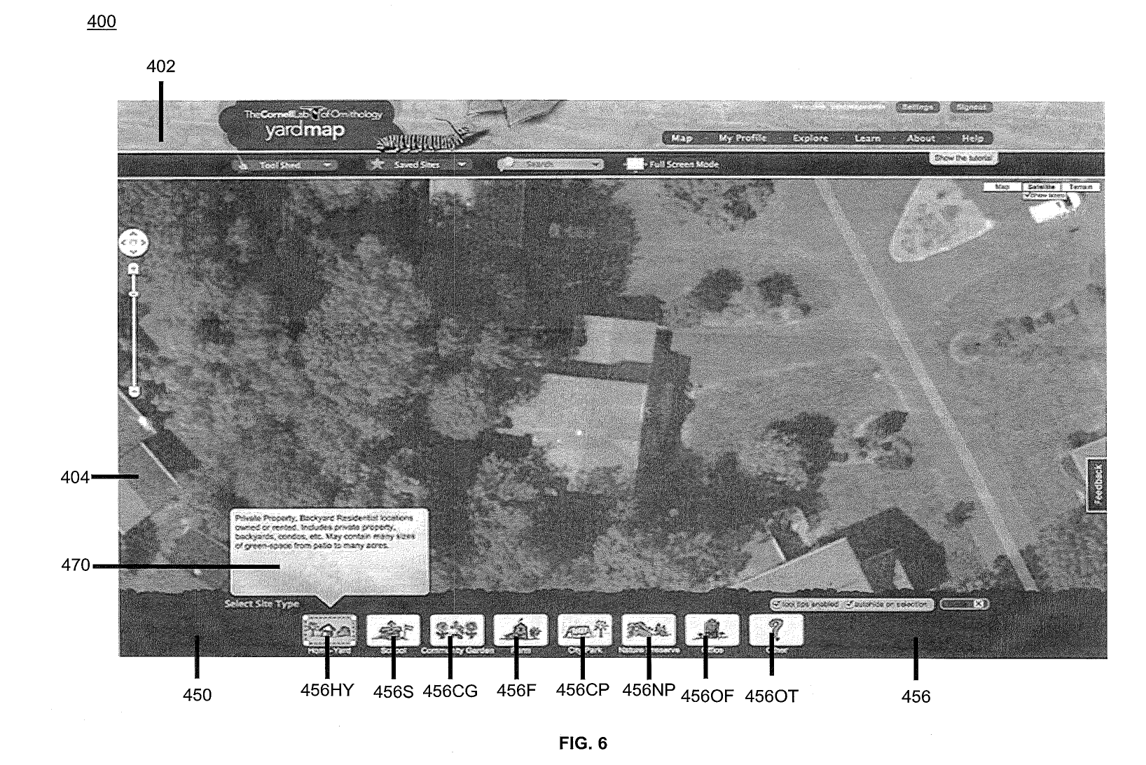

By selecting the button Outline Site 260S, the mapper is provided with a graphical control 450 in the form of a site type bar 456 as shown on the screen view 402 of FIG. 6. The site type bar 456 further includes graphical controls 450 in the form of buttons that include Home-Yard 456HY, School 465S, Community Garden 456CG, Farm 456F, City Park 456CP, Nature Preserve 456NP, Office 4560F, and Other 456OT. The user selects one or more site buttons of the site type bar 456 to categorize the parcel according to parcel type. The user may select Other 456OT to user-report a site not present within the site type bar 456.

FIG. 6 also illustrates the “quick view” box 470 that is a window of information. It is contemplated that any graphical control 450 may have a “quick view” box 470 that pops up when a user hovers over the feature represented by the graphical control 450.

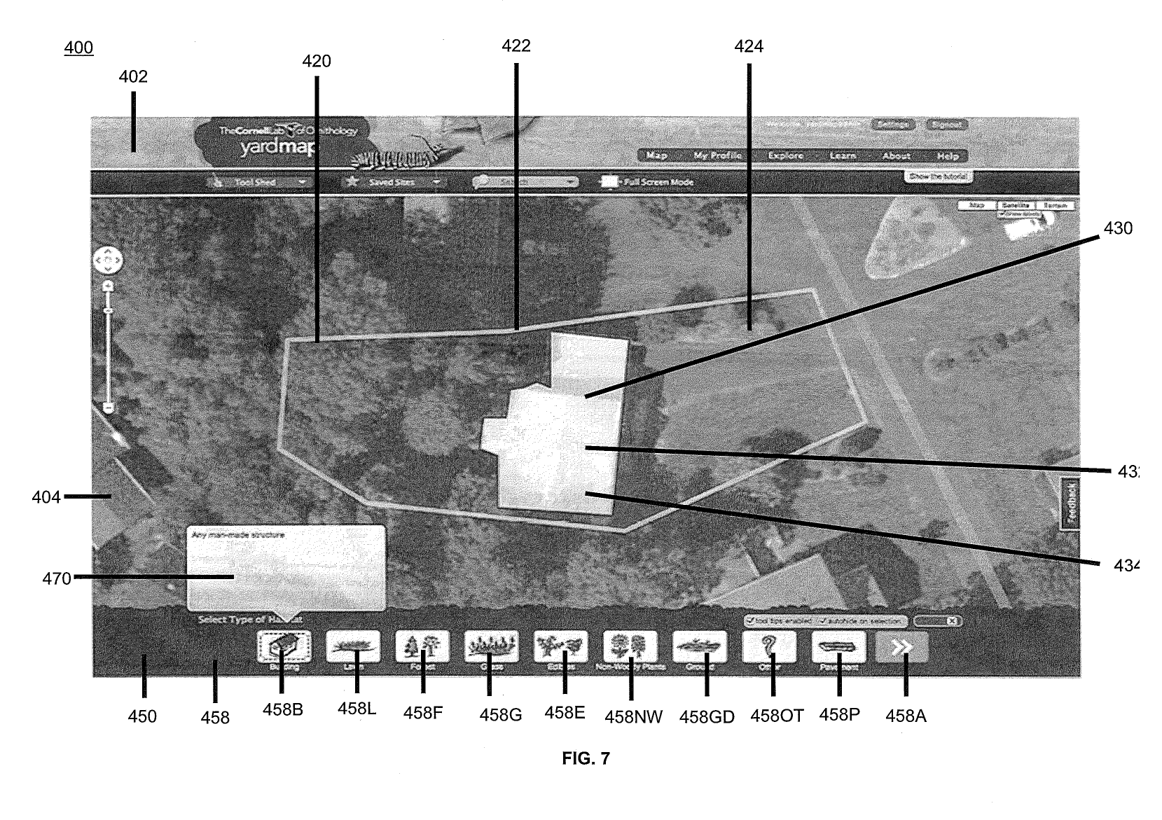

Upon the user selecting one or more site buttons of the site type bar 456 to categorize the parcel according to parcel type, the boundaries of the parcel map may be defined. As shown in FIG. 7, a virtual graphics tool 420 is used to compose a closed sequence of lines forming a polygon 422 that defines the parcel map or parcel map polygon 424.

By selecting the button Draw Habitat 260H as shown on FIG. 5, the mapper is provided with a graphical control 450 in the form of a habitat type library 458 as shown on the screen view 402 of FIG. 7. The habitat type library 458 further includes graphical controls 450 representing habitat components in the form of buttons including Building 458B, Lawn 458L, Forest 458F, Grass 458G, Edibles 458E, Non-Woody Plants 458NW, Ground 458GD, Other 4580T, and Pavement 458P (the Arrow button 458A may be engaged to provide “scrolling” sideways to facilitate the selection of additional buttons within the library that are not initially shown on the habitat type library 458). FIG. 7 also illustrates the “quick view” box 470 that pops up when a user hovers over the habitat component represented by the graphical control 450.

The user may select Other 4560T to user-report a habitat component not present within the habitat type library 458. User-reporting allows a user to define characteristics of the habitat component or provide data that is used to calculate the characteristics of the habitat component.

Upon the user selecting one or more habitat component buttons of the habitat type library 458, the habitat component is placed within the parcel map polygon 424 on the image 404 on the surface of the display interface 202 (FIG. 2). As shown in FIG. 7, Building 458B is selected from the habitat type library 458 and a virtual graphics tool 430 is used to create a polygon 432 thereby defining the building habitat component 434. It is also contemplated that the user may use a drag tool to drag the component to a desired size and/or shape.

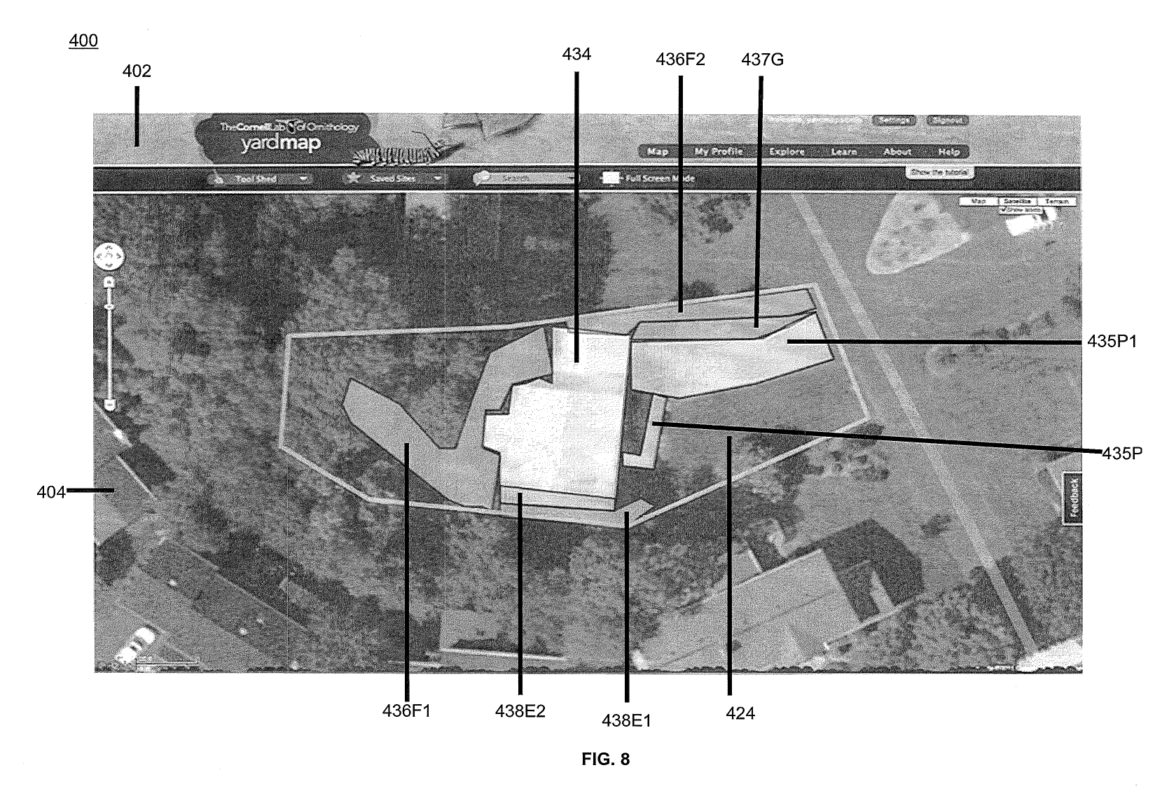

FIG. 8 illustrates a screen view 402 including a parcel map polygon 424 including the building habitat component 434, pavement habitat components 435P1, 435P2, forest habitat components 436F1, 436F2, grass habitat component 437G, and edibles habitat component 438E1, 438E2.

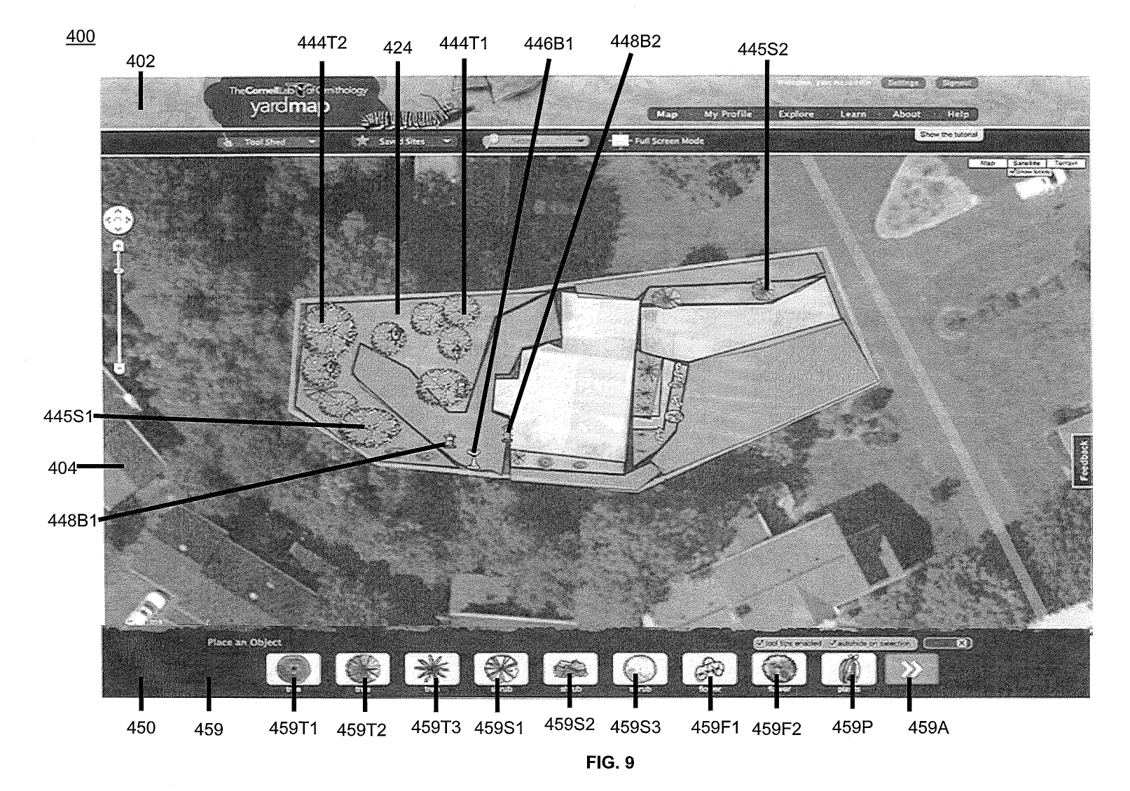

By selecting the button Place Objects 260P as shown on FIG. 5, the mapper is provided with a graphical control 450 in the form of an object type library 459 as shown on the screen view 402 of FIG. 9. The object type library 459 further includes graphical controls 450 representing object elements in the form of buttons including Tree 459T1, 459T2, 459T3, Shrub 459S1, 459S2, 459S3, Flower 459F1, 459F2, and Plant 459P (the Arrow button 459A may be engaged to provide “scrolling” action sideways to facilitate the selection of additional buttons within the library that are not initially shown on the object type library 459).

It is also contemplated that the mapper may user-report an object element not present within the object type library 459 by either defining characteristics of the object element or providing data that is used to calculate the characteristics of the object element.

Upon the user selecting one or more object element buttons of the object type library 459, the object element is positioned within the parcel map polygon 424 on the image 404 on the surface of the display interface 202 (FIG. 2). As shown on the screen view 402 of FIG. 9, the parcel map polygon 424 includes the tree object elements 444T1, 444T2, shrub object elements 44551, 445S2, bird bath element 446B1, and bird house elements 448B1, 448B2. When placing object elements, the user may use a drag tool to drag the feature to a desired size and/or shape. It is also contemplated that the user may use a virtual graphics tool to create a polygon thereby defining object elements.

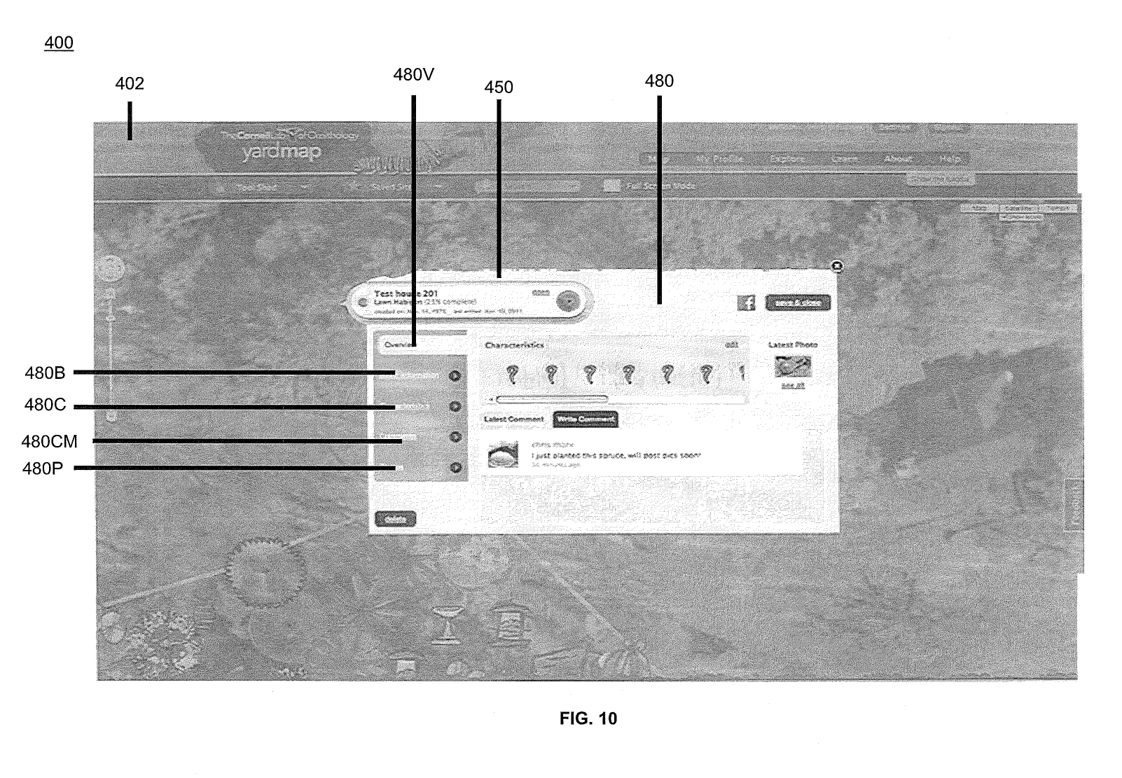

FIG. 10 through FIG. 15 illustrate screen views 402 of a feature window 480 that enables a mapper to interact with the social network through the feature—habitat component and object element—itself by performing an action. More specifically, each feature window 480 includes graphical controls 450 in the form of tabs that include Overview 480V, Basic Information 480B, Characteristics 480C, Comments 480CM, and Photos 480P.

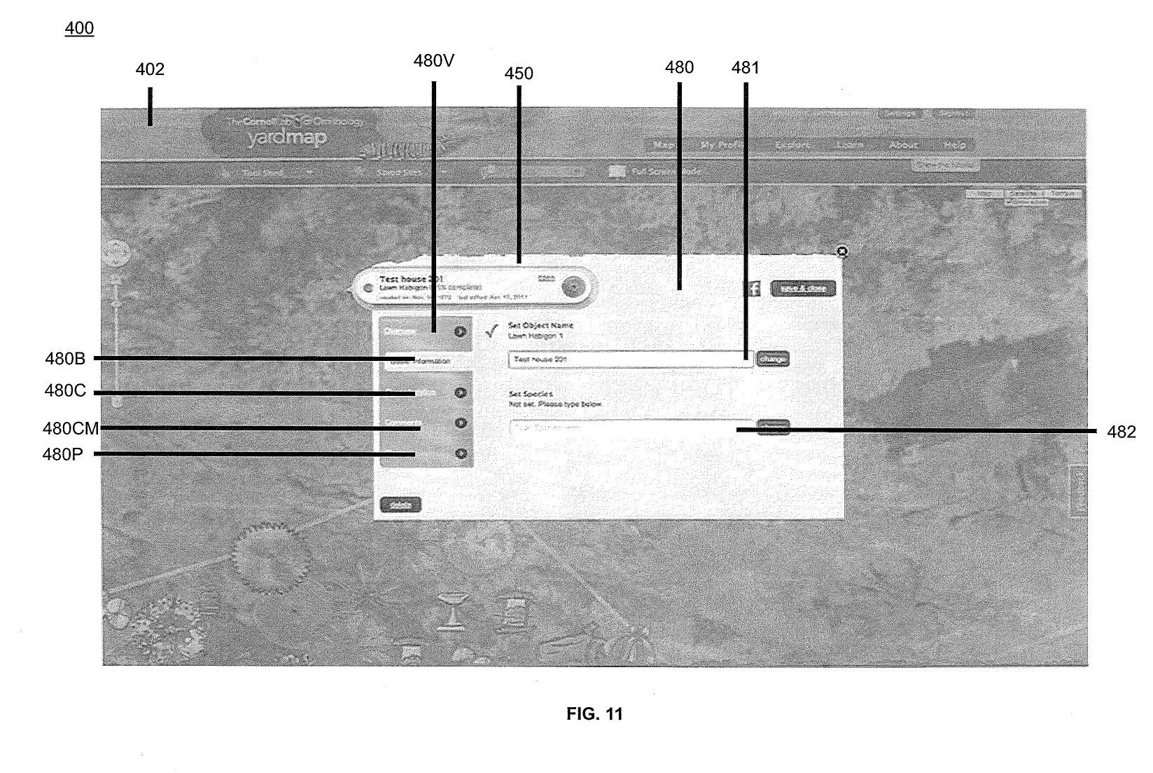

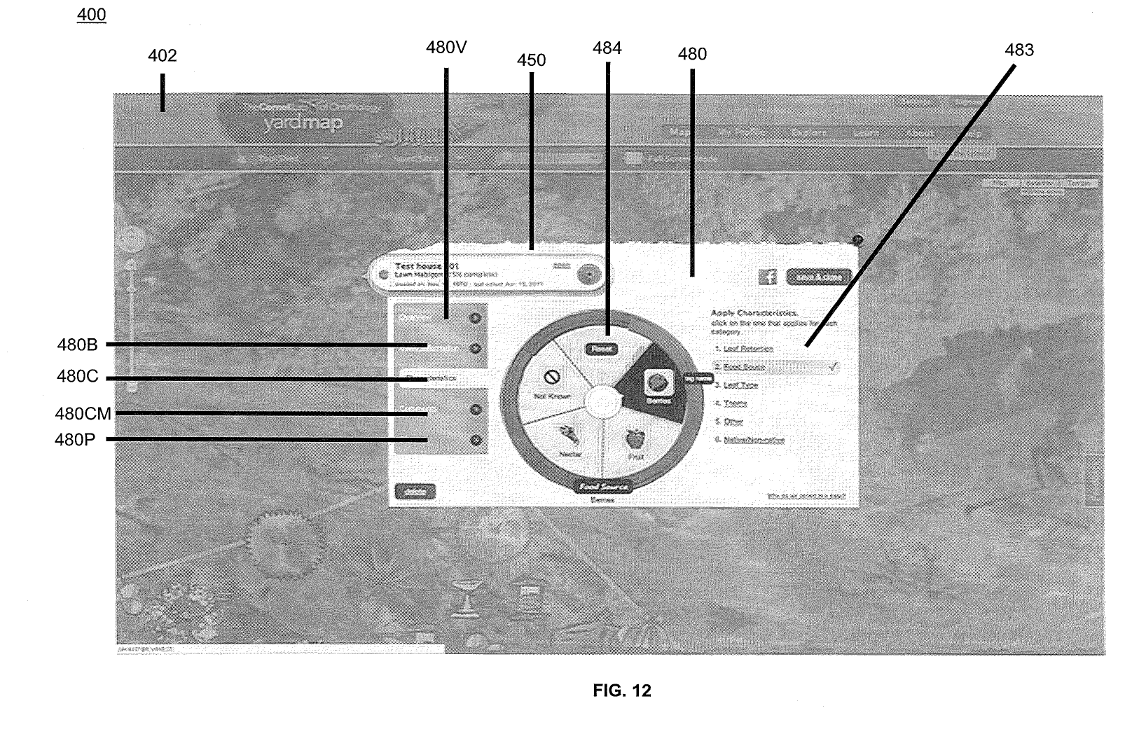

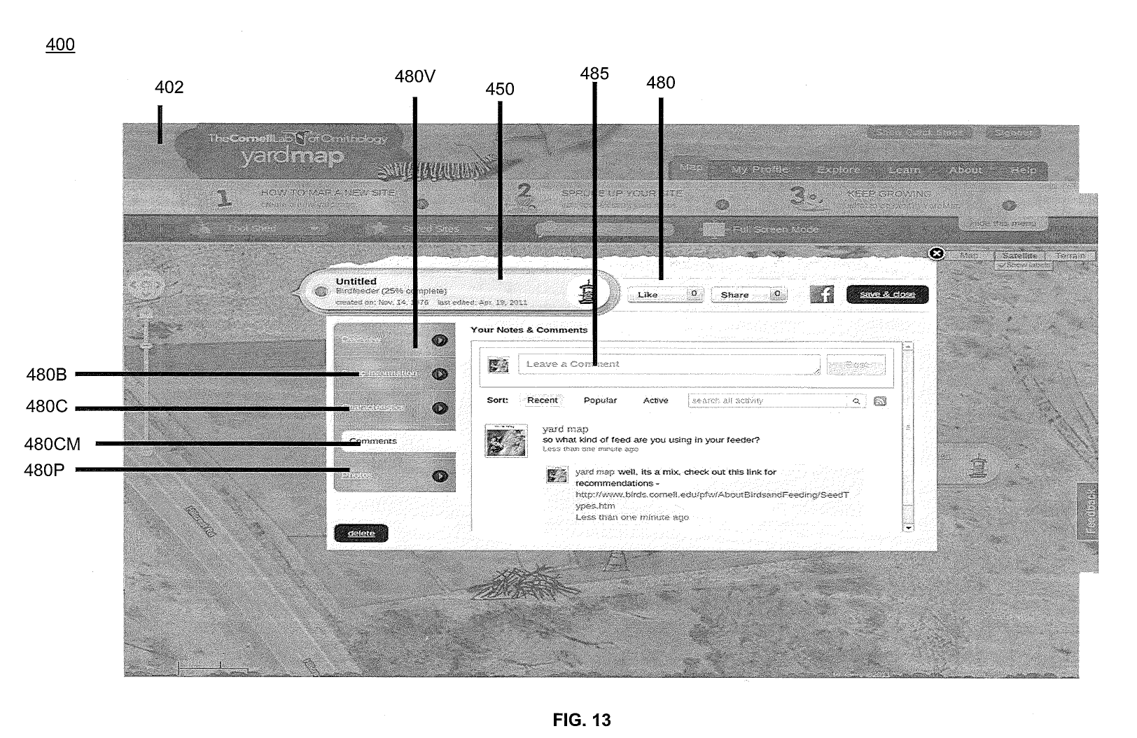

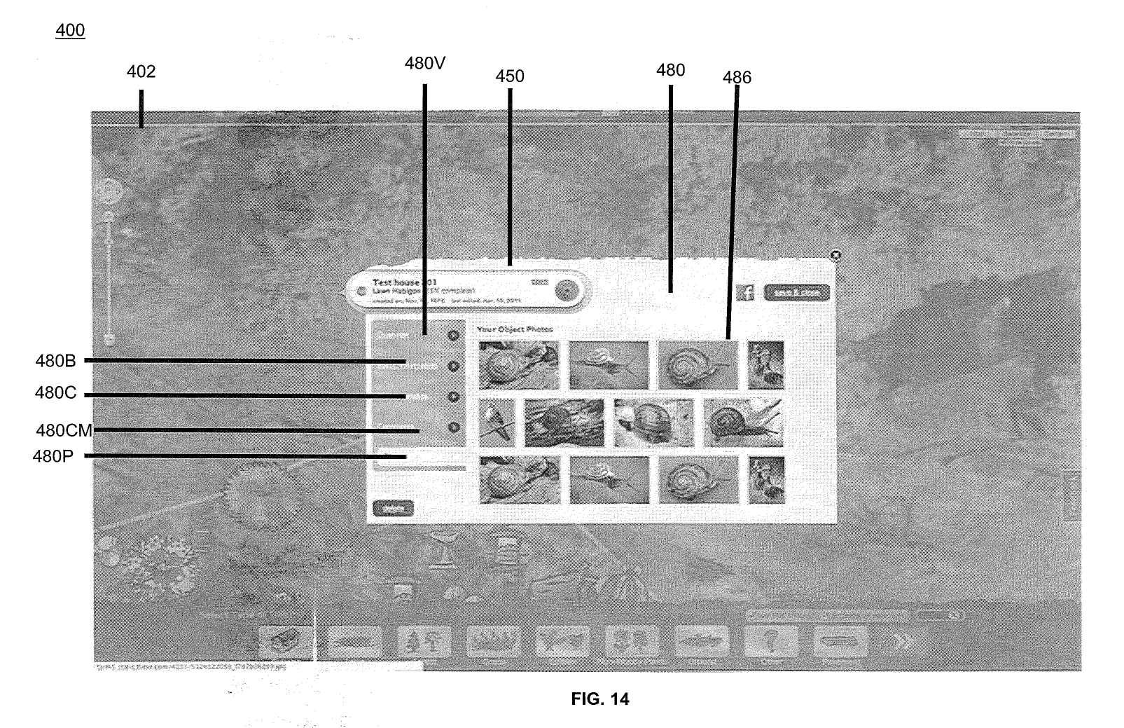

The Overview tab 480V as shown in the screen view 402 of FIG. 10 provides a summary of attributes related to a feature placed or positioned on the parcel map polygon 424 such as a habitat component or object element. As shown in the screen view 402 of FIG. 11, the Basic Information tab 480B, allows a user to assign a title 481 and well as specify species 482. It is contemplated that the mapper may link to other information to select a certain species, for example, the United States Department of Agriculture (“USDA”) plant list. Characteristics tab 480C shown in the screen view 402 of FIG. 12 allows a mapper to select characteristics or to user-input characteristics related to a feature placed or positioned on the parcel map polygon 424. As shown more specifically on FIG. 12, the user may select graphical controls 450 in the form of hyperlinks related to characteristics categories 483, specifically Leaf Retention, Food Source, Leaf Type, Thorns, Other, Native/Non-native. The Characteristics tab 480C also includes a graphic 484—here a pie chart—that summarizes each characteristics category 483. In addition to a pie chart, graphic 484 may be any illustration such as a bar chart, line graph, area graph, waterfall chart, polar chart, etc. As shown in FIG. 13, comments tab 480CM allows the mapper to post a comment within a comment box 485 to the social network as well as provide a status tag such as “point to”, “like”, “flag” and “share”. Any comments posted by the mapper designing and planning the parcel map are instantaneously accessible by others of the social network to view. Additionally, users may also post comments such as those in response to previously posted comments. Photos tab 480P as illustrated in FIG. 14 allows a user to upload photos and videos in a photo area 486 for display to users of the social network. The photos tab 480P also allows a user to upload sounds for delivery in the social network.

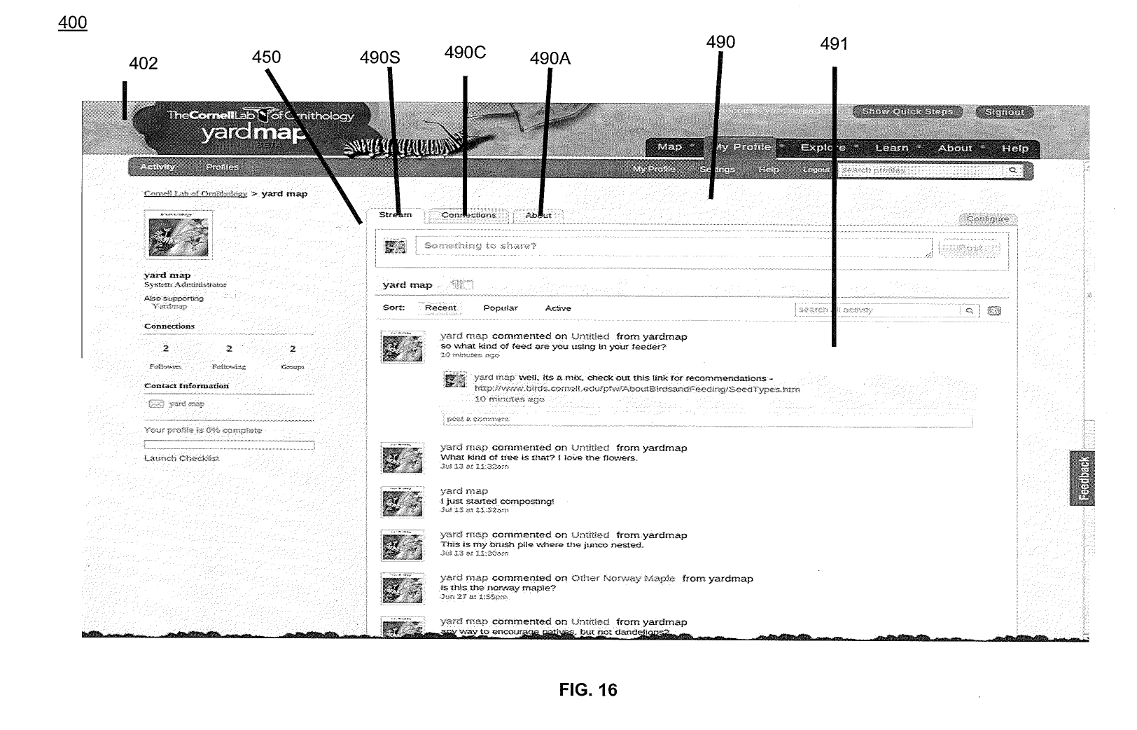

FIG. 15 illustrates a screen view 402 of a profile window 487 that results from selecting the My Profile button 452MP as shown on FIG. 4. The profile window 487 allows mappers to designate specifics regarding his or her profile, for example, name, login, password, address, contact information, badges, etc. The My Profile button 452MP also allows users to post and review comments and notes as well as connect with other users as shown more specifically in reference to FIG. 16. Furthermore, the profile window 487 allows a mapper to designate badges that may be associated with the user. A badge represents a unique identifier of the user, which may be placed on any parcel map within the habitat mapping application 400.

The invention provides a learning tool such that users can learn about the consequences or impact a particular design has on a parcel. Consequences are calculated from analyzing the parcel map and can be anything related to a particular architectural landscape. As shown in FIG. 15, one consequence is a sustainability comparison 488. The habitat mapping application 400 permits an understanding of consequences of landscaping practices and products and particularly how land or a site can be designed and managed to obtain a certain result such as to minimize negative effects and maximize positive effects on a parcel map polygon.

FIG. 16 illustrates a screen view 402 of a social network window 490 when a mapper accesses the social network of the invention. In one embodiment, the social network window 490 may be accessed through the My Profile button 452MP as shown on FIG. 4. The social network window 490 includes graphical controls 450 in the form of tabs that include Stream 490S, Connections 490C, and About 490A. The Stream tab 490S allows a mapper to post and view comments in a comments window 491. In certain embodiments, comments are published instantaneously on the social network. The Connections tab 490C allows a mapper to connect with users sharing the same or similar interest. It is contemplated that a user may be a person, group of people, entity, institution, company, etc. The About tab 490A lists information related to the social network of the invention.

While the invention has been described with reference to particular embodiments, those skilled in the art will recognize that many changes may be made thereto without departing from the scope of the invention. Each of these embodiments and variants thereof is contemplated as falling with the scope of the claimed invention, as set forth in the following claims.

1. A social network computer method for determining the effect of a particular environmental design created by a user, comprising the steps of:
accessing a web mapping service application;
constructing a parcel map polygon to define the boundaries of a parcel map;
categorizing the parcel map according to a parcel type;
choosing a habitat component to obtain a chosen habitat component;
placing the chosen habitat component on the parcel map to obtain a placed habitat component, wherein said placing step further comprises the step of generating a habitat polygon to define the borders of the placed habitat component;
selecting an object element to obtain a selected object element;
positioning the selected object element on the parcel map to obtain a positioned object element, wherein said positioning step further comprises the step of dragging the positioned object element to a particular size;
analyzing the parcel map including the placed habitat component and the positioned object element; and
sharing a result with at least one other user of the social network.

2. The method of claim 1 further comprising the step of:
providing a feature window associated with at least one of the parcel map polygon, the placed habitat component, and the positioned object element, wherein the feature window is configured for the user to assign a title, post a comment, display a photo, display a video, deliver sound, distinguish attributes, and provide a status tag.

3. The method of claim 1, wherein the result is at least one consequence of the placed habitat component and the positioned object element on the parcel map.

4. The method of claim 1, wherein said selecting step further comprises the step of identifying characteristics of the object element.

5. The method of claim 3, wherein the at least one consequence is at least one selected from the group of: land surface temperature, percent law pesticide use, water consumption, type of conservation strategy, energy consumption, carbon footprint, carbon footprint reduction strategy, carbon emissions, and reported pollution reduction.

6. The method of claim 1, wherein the web mapping service application is Google® Maps.

7. The method of claim 1, wherein the parcel type is at least one from the group comprising home, school, community garden, farm, park, nature preserve, and office.

8. The method of claim 1, wherein the habitat component is at least one from the group comprising building, lawn, forest, grass, desert, edible, flower, herb, ground, pavement, shrub, water, and wetland.

9. The method of claim 1, wherein the object element is at least one from the group comprising bush, tree, flower, grass, shed, bird feeder, bird house, rock, dead wood, mulch, compost bin, rain barrel, solar panel, birdbath, rock, windmill, geothermal station, brushpile, and snag.

10. The method of claim 1 further comprising the step of inputting an object element, wherein said inputting step further comprises the steps of:
supplying an illustration of the object element; and
designating characteristics of the object element.

11. A computer system for a user to design an environment, comprising:
a web mapping service application comprising:
a plurality of land areas, wherein each land area comprises a computer representation of a piece of land;
a database comprising:
a parcel type library of land categories;
a habitat library of virtual habitat components; and
an object library of virtual object elements;
a user interface for creating a designed parcel map comprising:
a first user interface component configured for retrieving a land area and constructing a polygon that defines the boundaries of a parcel map on the land area;
a second user interface component configured for selecting a land category from the parcel type library to categorize the parcel map;
a third user interface component configured for placing a habitat component on the parcel may by choosing a habitat component from the habitat library and generating a habitat polygon to define the borders of the habitat component; and
a fourth user interface component configured for positioning an object element on the parcel map by selecting the object element from the object library and dragging the object element to a particular size;
a processor configured for analyzing the designed parcel map to obtain at least one result; and
an internet connection for participating in a social network including sharing the at least one result regarding the designed parcel map with users of the social network.

12. The system of claim 11, wherein the computer representation is a satellite image.

13. The system of claim 11, wherein the third user interface component is further configured for providing a habitat feature window associated with the habitat component such that the user can assign a title to the habitat component or post a comment related to the habitat component.

14. The system of claim 11, wherein the fourth user interface component is further configured for providing an object feature window associated with the object element such that the user can assign a title to the object element or post a comment related to the object element.

15. The system of claim 11, wherein the first user interface component is further configured for providing a parcel feature window associated with the designed parcel map such that the user can assign a title to the designed parcel map or post a comment related to the designed parcel map.

16. The system of claim 11, wherein the object element is selected from the object library by identifying characteristics of the object element.

17. The system of claim 11, wherein the result is at least one selected from the group of: land surface temperature, percent law pesticide use, water consumption, type of conservation strategy, energy consumption, carbon footprint, carbon footprint reduction strategy, carbon emissions, and reported pollution reduction.

18. The system of claim 11, wherein the web mapping service application is Google® Maps.

19. The system of claim 11 further comprising a fourth user interface component configured for inputting an object element including supplying an illustration of the object element and designating characteristics of the object element.

20. The system of claim 11, wherein the result is at least one consequence of the designed parcel map.
